(19) United States
(12) Patent Application Publication
(10) Pub. No.: US 2008/0165706 A1
(43) Pub. Date: Jul. 10, 2008

(54) Destination service selection for a telephone

(76) Inventor: Bruno Bozionek, Borchen (DE)

Correspondence Address: Siemens Corporation;Intellectual Property Department, 170 Wood Avenue South, Iselin, NJ, 08830, US

(21) Appl. No.: 11/650,027

(22) Filed: Jan. 5, 2007

(51) Int. Cl. H04L 12/16

(52) U.S. Cl. 370/259

(57) ABSTRACT

Systems and methods for determining a service to be accessed by a telephony device are provided. Such systems or methods may provide one or more of: querying for service related information data for services, the plurality of services provided to the telephony device by at least one service device; selecting one of the services based on the service related information data; gaining access to a selected one of the services by addressing a service device specific destination address of the selected one of the services via a service specific communication protocol.

### FIELD OF INVENTION

Embodiments may generally relate to telephony, which in parts is based on packet-oriented principles. More particularly, some embodiments are concerned with selecting one of several services provided to a telephony device.

### BACKGROUND OF INVENTION

In conventional internet protocol based telephony networks for voice communication, telephony devices often implement different communication protocols, so that a connection can be set up to a large variety of other telephony devices. The prerequisite for a successful call set-up would merely be that a called telephony device would implement at least one of the communication protocols of a calling device. A communication protocol in that respect can be for example SIP (Session Initiation Protocol)—defined by the IETF (Internet Engineering Task Force) in a request for comments (RFC)—or H.323, a recommendation of the ITU-T (Telecommunications Standardization Sector of the International Telecommunication Union). As an example, if a telephony device supports both SIP and H.323, then it can connect directly to other SIP compliant devices and to other H.323 compliant devices. Furthermore it can connect to devices that also implement both SIP and H.323 by using one of the two communication protocols interchangeably.

For determining which communication protocols are supported by a to be called telephony device or more generally, what different services are available for a given destination telephone number, a DNS server (DNS: domain network service) can be queried, to determine which communication protocols are available for a specific telephone number. For that query—sometimes referred to as ENUM lookup (ENUM: acronym for telephone number mapping)—typically an ENUM identifier of the to be contacted destination is provided. The DNS server will then return a list of URI's (URI: uniform resource identifier) in a specific format. In that format the list specifies all supported communication protocols and protocol specific addresses, via which the destination can be contacted for setting up a connection via the corresponding communication protocol.

More generally, by using ENUM, one single ENUM identifier can be used to define all possible services that are provided by devices of a specific user. For example the possible services could be a URL (uniform resource locator) of a web domain, an electronic mail address, or a SIP telephone URI. With that, different clients—e.g. an e-mail client, a telephone client, a telephone device—could access the same ENUM lookup service. Each of these clients then would retrieve a list of URI's and could then pick the appropriate one of the services from that list. As an example, an e-mail client performing an ENUM lookup would then select the e-mail service and a destination e-mail address from the list of services, because typically e-mail clients are only able to send e-mails to e-mail addresses but not to other addresses like SIP telephone URI's or the like. Therefore, even when a number of services are assigned to a given ENUM number, in most cases a client can easily select the only appropriate service and the only appropriate destination address from the list of URI's.

In cases in which a calling telephony device supports more than one communication protocol (e.g. both SIP and H.323) and the DNS server returns also at least two of the same communication protocols for a called telephony device (e.g. also supporting SIP and H.323), currently the calling telephony device or the user of that telephony device now has to select one of the possible communication protocols for setting up a connection to the called telephony device. After that selection the call can then be set-up.

### SUMMARY OF INVENTION

In current implementations it can happen that a communication protocol is selected, that does not provide the best possible service to the user. This problem increases, when a larger number of URI's is returned by the DNS server performing an ENUM lookup.

Some embodiments provide a system, method, program code and/or means for determining a service to be accessed by a telephony device.

According to some aspects of a system or a method for determining a service to be accessed by a telephony device, provided are querying for service related information data for each of at least two services, the at least two services provided to the telephony device by at least one service device, selecting one of the at least two services based on the service related information data, and gaining access to a selected one of the at least two services by addressing a service device specific destination address of the selected one of the at least two services via a service specific communication protocol.

In some aspects of an Internet Protocol telephony network system for determining a service to be accessed by a telephony device, the Internet Protocol telephony network system comprises at least one service device, a querying unit, a selecting unit, and the telephony device. The at least one service device provides services of at least two services and provides the at least two services to the telephony device and other telephony devices. The querying unit enables initiating a query for service related information data for each of at least two services. Furthermore the selecting unit selects one of the at least two services based on the service related information data. Additionally, the telephony device is enabled for gaining access to a selected one of the at least two services by addressing a service device specific destination address of the selected one of the at least two services via a service specific communication protocol.

In some aspects to determine a service to be accessed by a telephony device, the service device may be associated to a called telephony user and may be operated by the called telephony user. The services may be a SIP service, a H.323 service, or an e-mail service, among others, and may be associated to the called telephony user and can be used as destinations for connections from the telephony device.

In further aspects, the service related information data may comprise at least personal information data related to the called telephony user. In other aspects, the service related information data may comprise at least service device specific data related to the service device. Personal information data may be data which is specific to the called telephony user, e.g. indicating for each service operated by the called telephony user a chance whether the called telephony user can be reached by this service. Service device specific data may be data to e.g. indicate the availability of a service.

In aspects determining a service to be accessed by a telephony device, the service specific communication protocol may be a packet-oriented communication protocol. In further aspects, the telephony device may be a packet-oriented communication device, for example using voice over internet protocol mechanisms to establish connections.

According to alternative aspects that determine a service to be accessed by a telephony device, a service preference list information of the at least two services to the telephony device may be provided based on the queried service related information data. The service preference list information may indicate for each service the probability to reach a successful connection to the called telephony user or a service specific delay until when a called telephony user will have access to a connection or message issued be the telephony device. Furthermore the service preference list information may be utilized for the selecting of the one of the at least two services.

According to some aspects of a system or a method for determining a service to be accessed by a telephony device, service device specific destination address information items of the at least two services may be queried by the telephony device, based on a logical destination address information item. The service device specific destination address information items may be assigned to the logical telephone destination address information item. In some aspects of the invention the querying for service device specific destination address information items may be executed as an ENUM lookup. In further aspects of the invention, the querying for service device specific destination address information items may directed to a domain name service.

According to some aspects for determining a service to be accessed by a telephony device, prior to the querying for service device specific destination address information items, a query request including the logical destination address information item may be transmitted from the telephony device to the domain name service. The domain name service may return a list of possible services which are assigned to the logical destination address. Regarding the logical destination address, the logical destination address information may be formed as a telephone number in the ENUM format. The retrieved service device specific destination address information items may be provided as at least one of a SIP resource identifier—as a SIP URI—, an H.323 resource identifier, an e-mail address identifier, a URL of an internet web page.

In aspects for querying for service related information data, this service related information data may comprise at least one of location information—especially of the location of service devices and the location of the called telephony user—, presence information—especially presence information available for the called telephony user—, charging or billing information about the costs of a to be selected service and the costs of the corresponding transmission, and availability information of services and service devices.

In a further aspect of the invention, the service related information data may comprise information about an alternative service related to the one of the at least two services, so that a connection may be established to the alternative service instead of a primary service. Access may be gained to the alternative service related to the selected one of the at least two services by addressing a service device specific destination address of the alternative service via a communication protocol specific to the alternative service.

According to aspects of providing an alternative service, the information about an alternative service may comprise a destination address for a short message service so that instead of establishing a voice connection to a primary service device, a text message will be created and sent to the short message service.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram of a system according to some embodiments;

FIG. 2 is a flow diagram of a method for determining a service to be accessed by a telephony device according to some embodiments; and

FIGS. 3A and 3B illustrate different ways to arrange components for a method for determining a service to be accessed by a telephony device according to some embodiments.

### DETAILED DESCRIPTION

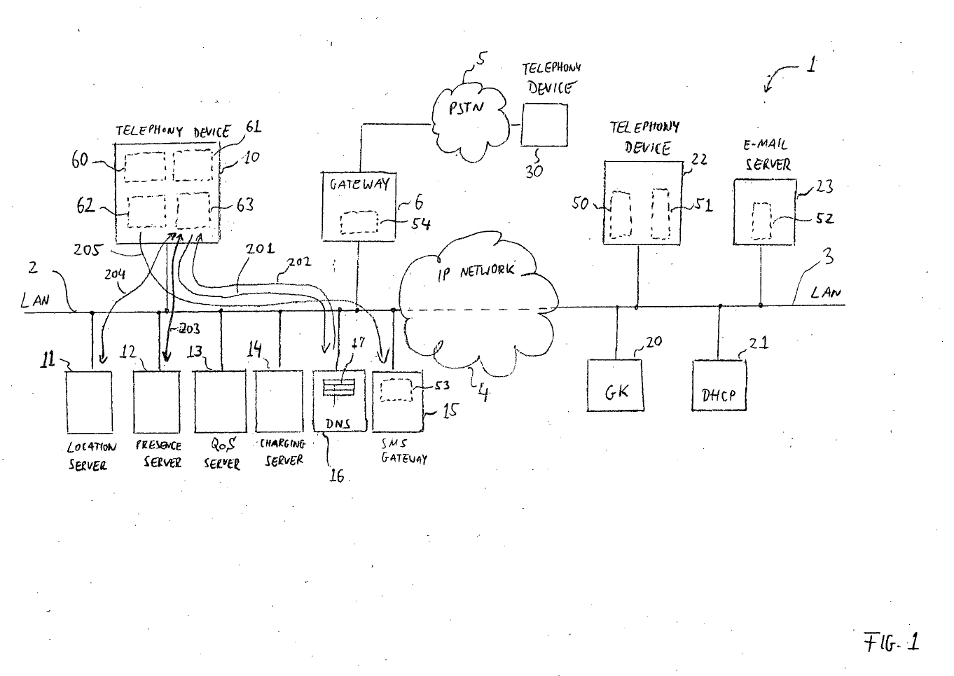

FIG. 1 is a block diagram of a system 1 according to some embodiments. The system 1 may be designed as an Internet Protocol telephony network system and comprises a first internet protocol based local area network 2 and a second internet protocol based local area network 3. Besides these packet-oriented networks which are both connected via an internet protocol network 4, a connection to a circuit-switched telephone network PSTN 5 is provided by a gateway 6 connected to the first internet protocol based local area network 2.

Besides these elements the system 1 comprises a number of servers and devices, which may be combined in a large number of combinations, one of which is shown in FIG. 1. Connected to the first local area network 2, the system 1 may comprise a first telephony device 10, several servers like a location server 11, a presence server 12, a QoS (QoS: quality of service) server 13, and a charging server 14. Each of these mentioned servers are configured to provide information about different connections and/or about different connection destinations in respect of the location of a destination, of presence information of a user, of quality information of a connection, or billing information of a connection. The information provided may be related to personal data of a to be called user or related to devices operated by the to be called user. Some embodiments may limit the servers to a subset of the previously mentioned servers, some embodiments may have further servers providing additional information.

A further server or gateway is connected to the first local area network 2 to provide an interface to a wireless text message system. This server is referred to as SMS-Gateway 15 (SMS: short message system) and provides means to transfer IP based text messages to wireless SMS text messages that can be sent to cellular telephony devices in a cellular, wireless network.

Additionally, a domain name server (DNS) 16 is connected to the first local area network 2. This domain name server 16 provides means for an ENUM lookup, based on evaluating a mapping table 17. Instead of a domain server 16 also alternative servers could be used as ENUM registration units and ENUM lookup servers. Furthermore also a plurality of ENUM registration units or DNS servers might be present in a network, which all may be queried.

Via the second local area network 3 a gatekeeper (GK) 20, a DHCP server 21 (DHCP: dynamic host configuration protocol), a telephony device 22, and an e-mail-server 23 are connected.

Furthermore the system 1 may comprise also further telephony devices, attached to the first or the second local area networks 2 and 3 (not shown) or connected to the circuit-switched telephone network PSTN 5. As an example telephony device 30 may be connected to the circuit-switched telephone network PSTN 5.

Each of the telephony devices 10, 22, or 30 might be implemented as a stand alone telephone or as a telephony client that runs as a software application on a personal computer. The system 1 provides means for setting up connections between these telephony devices 10, 22, 30, or further telephony devices, preferably by using internet protocol based methods and features. Optionally, some links of the connections may also be established via circuit-switched technology. Besides plain telephony features, the telephony devices 10, 22, and/or 30 may also support different functions like sending and receiving e-mails or further text messages.

In the following embodiment, the telephony device 10 may be set up to initiate a connection and to access services or resources provided by the telephony device 22, the e-mail server 23, the SMS gateway 15 or the gateway 6. Services provided by these devices are also incorporated into FIG. 1 as SIP services 50 and H.323 service 51, both provided by the telephony device 22, as an e-mail service 52 provided by the e-mail server 23, as an SMS service 53 provided by the SMS gateway 15, or as a SIP service 54 by the gateway 6. For using these services and for connecting to these services, in the telephony device 10—and in the other telephony devices 22 and/or 30 in a corresponding fashion—, service clients may be implemented to connect to these services. Specifically in FIG. 1 these service clients are a SIP client 60, a H.323 client 61, and an e-mail client 62. For managing the selection, which service client should be activated to set up a connection to a corresponding service, a service manager 63 is implemented in the telephony device 10—or may be implemented in a stand alone server.

In the given system, the telephony device 22, the e-mail server 23, the SMS gateway 15, and the gateway 6 can be seen as service devices, each providing a service to any device, which is addressing the respective device. Therefore the telephony device 10 might engage one of the provided services, preferably one at a time. The selection of one of the provided services may be dependent on a situation and dependent on a task to be performed at the telephony device 10.

Further details of the devices in the system 1 according to some embodiments are set forth below.

Based on FIG. 1 a method for determining a service to be accessed by the telephony device 10 is explained. Initiated by a request received at the telephony device 10 by a first user of that telephony device to connect to a specific second user and to setup a call, several processing steps are executed. First, it is determined by the service manager 63 of the telephony device 10, which services might be provided for the second user and could be used to fulfill the connection request. The second user may be identified by a telephone number like 1 212 1234567, which was entered by the first user at the telephony device 10.

As an intial step of the method, the telephone number will be converted into an easier to be processed format, for example the E.164 format (E.164: ITU-T recommendation which defines the international public telecommunication numbering plan). Based on that, a further transition is executed into the ENUM format, so that the dialed telephone number will now be present in a representation like this: 7.6.5.4.3.2.1.2.1.2.1.e164.arpa.

This ENUM identifier is then used as a logical destination address information item for querying the domain name server 16 to gather all services that are configured or registered for the given ENUM identifier. When receiving the query request from the service manager 63—indicated by message 201—, the domain name server 16 will execute an ENUM lookup in the mapping table 17. For the given embodiment there might be several URI entries or resource identifiers stored for the given ENUM identifier, which all then will be provided by the domain name server 16 to the service manager 63 for further processing—indicated by message 202. Specifically these URI's might be for the given system 1 a SIP URI to the SIP service 50 of the telephony device 22 (e.g. “sip:user2_sip@lan2.com”), a H.323 URI to the H.323 service. 51 of the telephony device 22 (e.g. “h323:user2_h323@lan2.com”), and an e-mail URI to the e-mail service 52 of the e-mail server 23 (e.g. “mailto:user2_sip@lan2.com”).

These URI identifiers will be used by the telephony device 10 as device specific destination address information items for addressing the specific services during the process of building a connection and maintaining a connection.

Before a connection is set up and prior to accessing one of the services, additional information will be gathered to find the most appropriate service to be addressed. Specifically for some or all of the retrieved URI identifiers service related information data will be determined. This additional information may be user specific personal data related to the second user or service specific data related to the services or devices operated by the second user or configured for the second user and may be gathered by querying at least one of the location server 13—indicated by message 204—, the presence server 12—indicated by message 203—, the QoS server 13, and/or the charging server 14 for service related information data. Besides, the availability of a device or a service will be checked and alternative destinations, in case a device or service is unavailable, will be determined. All this service related information data, which comprises data related to availability, cost, quality, location, presence, alternative destination services or further connection or destination specific information will then be provided to the service manager 63. Also some kind of preference rules can be evaluated that for example SIP connections will be preferred to H.323 connections.

The service related information data will be gathered and evaluated by the service manager 63, and used for selecting one service based on the service related information data. A selection of a service can be performed as a manual step provided to a user or automatically by the telephony device 10.

In general, the service related information data is supplementary information data about services of a user and provides data, which is related to a called user or a to be called user and the devices and services he operates. Therefore the selection of a service can be based on information specifying statuses of possible destinations or the called user, so that the best service can be selected manually or automatically by a calling user or a calling entity.

For the given example with a SIP, H.323, and an e-mail service that is returned to the service manager 63, the presence server 12 might return data indicating, that the user to be called might have set his presence status to be “out of the office”. This could be presented in a display at the telephony device 10 to the calling user or evaluated by an evaluation logic. The latter may have rules defined that in case of “out of office”, preferably the call should be redirected to a mobile phone, alternatively to an e-mail client, and last, to a SIP client or a configured recording machine. In the given embodiment—as an example—, no mobile phone is in the list of available services therefore a connection to the e-mail URI could be selected.

After selecting the e-mail URI, this URI can be used as a destination address for gaining access by the telephony device 10 to a selected one of the services—i.e. the e-mail service 52—by addressing the determined e-mail address as a service device specific destination address of the selected service 52. The access will be gained via well known protocols for e-mail communication by the e-mail client 62, which was selected from the available clients of the telephony device 10—indicated by message 205. In general, for gaining access and for establishing connections, service specific communication protocol will be used, based on the selected URI.

Specific to the example in which the e-mail URI is selected, there are several implementations possible, how this selected service can be used by the telephony device 10. For example the telephony device 10 provides means to enter text messages that then can be delivered to the selected e-mail service 52. Alternatively an audio message could be recorded via the telephony device 10, which then can be sent to the e-mail service 52 as an attachment of an e-mail.

With this system 1 and the previously mentioned method steps, additional user specific, service specific, and/or service device specific information can be gathered which can be used to provide the best possible service to a specific calling user at a specific time. For example, via the QoS server 13, data about the quality—e.g. the quality of speech, a delay of transmission—of different connections depending on the to be selected service could be compiled as service related information data. Evaluating this data it could be determined, that maybe in one example all SIP resources are already taken in a network link, so that as a result H.323 message transmission is selected as an alternative, or that a utilization of a different network link is performed.

In another embodiment the location server 11 might provide information that a called user might be available via his home telephone but not via his business telephone. Furthermore also the home telephone number is provided. Both of this information is taken as service related information data as a basis for a service selection. Considering this information, the SIP server 54 of the gateway 6 might be selected as a service for a connection, because this gateway 6 may then route the call from the gateway 6 via the circuit-switched telephone network PSTN 5 to the telephony device 30.

In a further embodiment charging or billing information might be considered by querying the charging server 14. The possible costs for the different connections might be returned as service related information data. In a possible scenario the primary services will be too costly so that a cheap SMS service 53 is selected to be accessed for a to be set up connection.

In any case, based on the selected service, a client corresponding to the service is selected to perform the call or to perform connection handling. In the given embodiment, one of the SIP client 60, the H.323 client 61, or the e-mail client 62 will be selected, but further clients might be available. If no proper client is present, then merely a message is displayed to the user of the telephony device 10 or possibly the call is transferred to an associated device which also can be operated by the same user.

In some embodiments a preference list for the services is compiled and provided to the telephony device as service preference list information of the services based on the queried service related information data, i.e. based on the service URI's. This service preference list information is then utilized for the selecting of the one of the services.

In some embodiments the telephony device 10 may be arranged as a telephony client application running on a personal computer. This allows a tight integration of telephony, e-mail messaging, and chat messaging features.

In a further embodiment the telephony device 10 may be a standard circuit switched telephone, which might be coupled to one of the local area networks via a gateway. In this case most of the logic for querying and selecting data or services is incorporated into the gateway.

The selected client of telephony device 10 then may set up a connection to the selected service. The service providing device might be contacted directly or via generally known principles like using DHCP by contacting the DHCP server 21 or the gatekeeper 20 for the destination device.

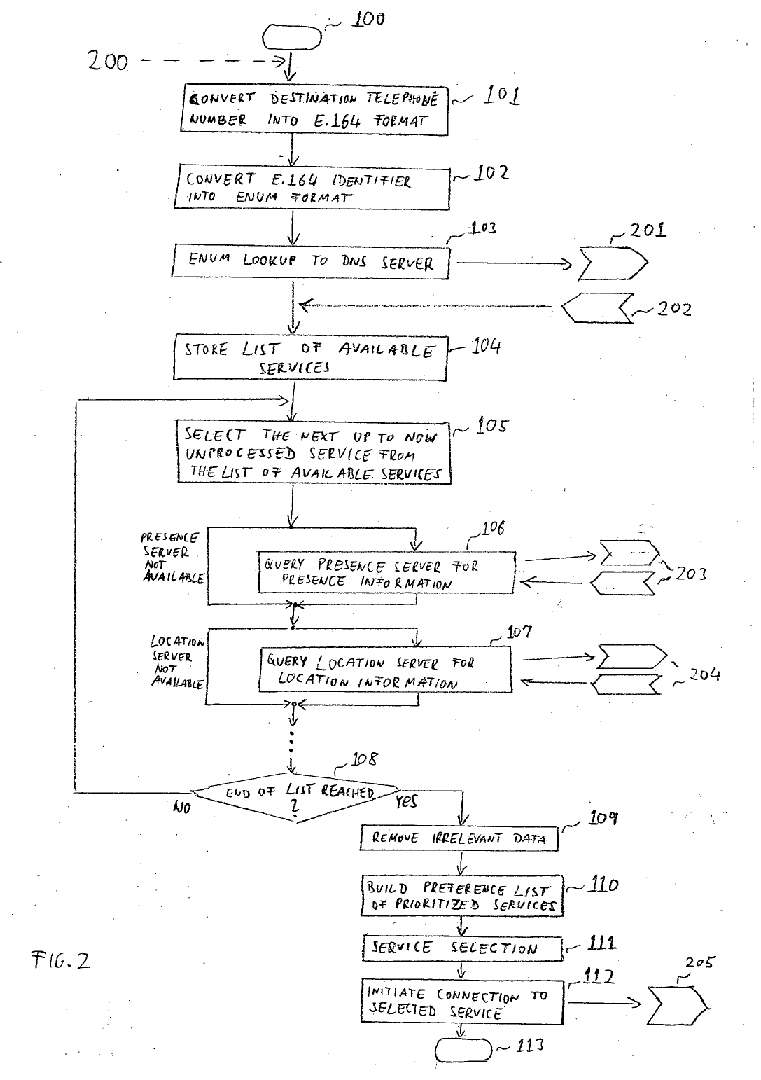

Based on the system 1 of FIG. 1, the previously explained method is shown another time in a further embodiment illustrated as a flow diagram of FIG.2, in which executed steps of the telephony device 10 are visualized. When a call initiation request 200 or a call setup request is identified or received, the telephony device 10 leaves its initial state 100. In step 101 the entered or provided telephone number will be converted to an E.164 identifier or such a conversion is initiated. Based on the result of that conversion, the E.164 identifier is converted in a further step 102 to a corresponding ENUM identifier.

In step 103 an ENUM lookup is performed by issuing an ENUM lookup message 201 to query the domain name service 16 or another server that could provide such an ENUM lookup for service device specific destination address information of provided services, based on the ENUM identifier as a logical destination address information item. As a response to that query a list of URI's is returned in message 202 as the queried service device specific destination address information items.

Performing step 104, the retrieved list will be stored temporarily as a list of possibly available services.

Now, executed in a loop for each entry of the retrieved list of services, service related information data will be gathered for each service in the list of services. In the loop in a first iteration the first or—in a further iteration of the loop—the next entry in the list will be selected—step 105—and then several servers will be contacted to query for this service related information data. Exemplarily, in step 106 a presence server is queried via message 203 to gain information about a presence status of the called user, and in step 107 a location server is queried via message 204 to gain information about location information of a called user or devices corresponding to the addressed ENUM identifier. If such a respective server is not present in the network or not configured, then querying that respective server is bypassed. Further servers might be queried, indicated by three dots in FIG. 2.

In step 108 it is checked whether all entries in the list of services have been processed in respect of querying service related information data. If not, then processing is continued in step 105 and the next entry is processed. If all entries have been processed then processing in continued in step 109—which might not be necessarily present—by removing data that is irrelevant to the selection of the most appropriate service. For example if a telephony device 10 is not able to perform email connections then all information regarding e-mail services and e-mail communication can be discarded.

Based on the list of services and the gathered service related information data, a preference list of to be contacted services will be created in step 110. The preference list is a list of prioritized services indicating the service that should be selected. To build the preference list, a rule based engine may be existing to evaluate the service related information data and to evaluate which service might be the most appropriate for a specific situation.

In step 111 based on the preference list, if available, or based on the gathered service related information data, a service will automatically be selected or will be offered to a user of telephony device 10 for manual selection. Once the selection occurs and once the selection is processed by the telephony device 10, a connection can be set up in step 112 from the telephony device 10 to the specified device providing that service. For this connection, a set-up request message 205 will be sent to the selected service device specific destination address. This service device specific destination address may optionally be modified or evaluated by network entities like routers, gatekeepers and/or DHCP servers. Eventually the message 205 will be routed to an end point to accept the call or the connection.

With this, the connection set-up phase is finished and the connection will stay established. The telephony device 10 will then pass on to an “in connection” state—state 113.

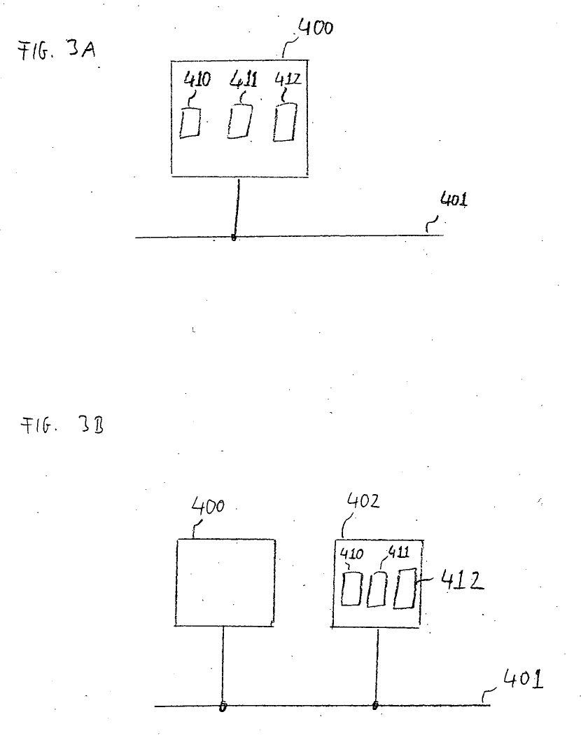

FIGS. 3A and 3B show two of several possible implementations for some of the units involved in the method for determining a service to be accessed by a telephony device.

FIG. 3A shows a telephony device 400, which comprises an ENUM lookup client 410, a querying client 411 as a querying unit, and a selecting unit 412 as integral units. The telephony device furthermore is connected to a network 401, possibly a local area network.

The ENUM lookup client 410 provides mechanisms and/or methods for querying for available service device specific destination address information items and for available services. The querying client 411 is set up for initiating a query for service related information data for each of the available services. And based on this gathered information, a service selection is performed by the selecting unit 412 based on the service related information data.

Gaining access to a selected one of the services by addressing a service device specific destination address of the selected one of the services is then executed by the telephony device 400 and its further built-in components.

In FIG. 3B the same components are available as in FIG. 3A, but in a different arrangement. The telephony device 400 may be separate from the further units, so that a known telephone may be used without major modification. The telephony device 400 is coupled via the network 401 to a separate device, a service selection support unit 402. The latter comprises the previously mentioned ENUM lookup client 410, querying client 411, and selecting unit 412 as units of this service selection support unit 402. With this arrangement it might be possible to have only a single instance of ENUM lookup client 410, querying client 411, and selecting unit 412 for more than one telephony device in the network.

The system structure shown in FIG. 3B may further be modified so that some of the services will be located in usually already present gateways or routers. E.g. a SIP gateways intended to connect analog or digital circuit-switched telephones to a packet-based network using SIP, may comprise one or several of the ENUM lookup client 410, querying client 411, and selecting unit 412.

In some embodiments the service related information data comprises availability information. As an example it might be determined, whether a server of a to be contacted service is present and running, whether the server is congested, whether network links along the to be used communication path are congested or blocked. Furthermore user rights may also be checked, regarding the rights to access a specific service.

In some embodiments querying for service related information data might also provide information related to alternative services or backup services and related addresses, so that access to the alternative service related to a selected one of the services may be gained by addressing a service device specific destination address of the alternative service via a communication protocol specific to the alternative service.

In further embodiments, when performing an ENUM lookup, NAPTR (Naming Authority Pointer) resource records may be queried or parsed. These NAPTR resource records may be returned or may be modified into a different format before passed to a querying client.

Generally when the term “data” is used in this document, e.g. service related information data, service device specific data, personal information data, this term will cover a single item of data or a plurality of items of data without limitation.

Embodiments described above are not intended to be limited to the specific form set forth herein, but are intended to cover such alternatives, modifications and equivalents as can reasonably be included within the spirit and scope of the appended claims.

What is claimed is:

1. A method for determining a service to be accessed by a telephony device, comprising:
querying for service related information data for each of a plurality of services, the plurality of services provided to the telephony device by a service device;
selecting one of the plurality of services based on the service related information data; and
gaining access to a selected service by addressing a service device specific destination address of the selected service via a service specific communication protocol.

2. The method according to claim 1,
wherein the service device is associated to a called telephony user, and
wherein the service related information data comprises at least one of personal information data related to the called telephony user and service device specific data related to the service device.

3. The method according to claim 1,
wherein the service specific communication protocol is a packet-oriented communication protocol, and
wherein the telephony device is a packet-oriented communication device.

4. The method according to claim 1, further comprising:
providing a service preference list information of the plurality of services to the telephony device based on the queried service related information data; and
utilizing the service preference list information for the selecting of the one of the plurality of services.

5. The method according to claim 1, further comprising querying, by the telephony device, for service device specific destination address information items of the plurality of services, based on a logical destination address information item, the service device specific destination address information items are assigned to the logical telephone destination address information item.

6. The method according to claim 5, wherein the querying for service device specific destination address information items is executed as an ENUM lookup.

7. The method according to claim 5, wherein the querying for service device specific destination address information items is directed to a domain name service.

8. The method according to claim 7, wherein a query request including the logical destination address information item is transmitted from the telephony device to the domain name service prior to the querying for service device specific destination address information items.

9. The method according to claim 5, wherein the logical destination address information is formed as a telephone number in the ENUM format.

10. The method according to claim 5, wherein one of the service device specific destination address information items is provided in the format of a SIP resource identifier, in the format of an H.323 resource identifier, or in the format of an e-mail address identifier.

11. The method according to claim 1, wherein the service related information data includes an item selected from the group consisting of location information, presence information, charging information, availability information, and information about an alternative service related to the one of the plurality of services.

12. The method according to claim 11, further comprising gaining access to the alternative service related to the selected service by addressing a service device specific destination address of the alternative service via a communication protocol specific to the alternative service.

13. A method according to claim 12, wherein the information about an alternative service comprises a destination address for a short message service.

14. An Internet Protocol telephony network system, comprising:
a service device providing services of plurality of services provided to telephony devices;
a querying unit for initiating a query for service related information data for each of plurality of services;
a selecting unit for selecting one of the plurality of services based on the service related information data; and
a telephony device for gaining access to the selected service by addressing a service device specific destination address of the selected service via a service specific communication protocol.

15. The system according to claim 14,
wherein the service device is associated to a called telephony user, and
wherein the service related information data comprises at least one of personal information data related to the called telephony user and service device specific data related to the service device.

16. The system according to claim 14,
wherein the service specific communication protocol is a packet-oriented communication protocol, and
wherein the telephony device is a packet-oriented communication device.

17. The system according to claim 14,
wherein a service preference list information of the plurality of services to the telephony device is provided based on the queried service related information data, and
wherein the service preference list information is utilized for the selecting of the one of the plurality of services.

18. The system according to claim 14,
wherein the telephony device queries for service device specific destination address information items of the plurality of services, based on a logical destination address information item, and
wherein the service device specific destination address information items are assigned to the logical telephone destination address information item.

19. The system according to claim 14,
wherein the querying for service device specific destination address information items is executed as an ENUM lookup.

20. The system according to claim 14,wherein the service related information data comprises information about an alternative service related to the one of the plurality of services.

21. The system according to claim 20, wherein access to the alternative service related to the selected service is gained by addressing a service device specific destination address of the alternative service via a communication protocol specific to the alternative service.

22. The system according to claim 21, wherein the information about an alternative service comprises a destination address for a short message service.
